(19) United States
(12) Patent Application Publication
(10) Pub. No.: US 2013/0238474 A1
(43) Pub. Date: Sep. 12, 2013

(54) Systems and Methods for Gathering and Transmitting Content Royalty Payment Information

(71) Applicant: Geoffrey S. Nagel, Decatur, GA (US)

(72) Inventor: Geoffrey S. Nagel, Decatur, GA (US)

(21) Appl. No.: 13/796,413

(22) Filed: Mar. 12, 2013

Related U.S. Application Data
(60) Provisional application No. 61/609,694, filed on Mar. 12, 2012.

(51) Int. Cl. G06Q 30/04

(52) U.S. Cl. CPC G06Q 30/04
USPC 705/34

(57) ABSTRACT

The present disclosure describes various embodiments of a content royalty payment system and methods for providing a computer-implemented content royalty payment data output relating to royalty payments due under contracts between a media system operator and content owners. The embodiments describe a system for gathering and exchanging content royalty payment information among content providers and content distributors. The embodiments include user interfaces through which the various users access system functionality in a secure manner. The embodiments also include a database which stores all applicable data, including authorized content distributors and content providers, product catalogs, content royalty payment information, application settings, etc. Further, the embodiments include a Routing & Interface Module to facilitate the exchange of information between a content distributor and its many content providers. The Routing & Interface Module is capable of importing data from content distributors using a defined API and of exporting data to content providers via a defined API or by producing an output file. The Routing Engine also monitors contractual deadlines and provides transaction receipts.

### TECHNICAL FIELD

The present application relates generally to media distribution and management systems, and more particularly to methods and systems for gathering content royalty payment information from content distributors and transmitting it to content providers for use in royalty calculations, taking into account various variables and rules, and performing complex computations.

### BACKGROUND

Generally, content distributors negotiate and sign royalty contracts with content providers to gain the rights for distributing content to consumers. Content distributors can include cable television providers (COMCAST®, Time-Warner®, Charter®), telcos, and terrestrial or satellite TV providers (DirecTV, Dish Network). Content providers can include Pay television networks (MTV, Fox, ESPN), broadcast networks (ABC, CBS, NBC), movie studios (Disney, Fox) and other such providers. These royalty contracts are often complex, having several calculable provisions, each different for each content provider, such as the royalty rate to be paid per unit of content purchased. One way of calculating royalties is to determine the number of customers (subscribers) that subscribe to a particular channel package (called ‘tiers’), and then pay the content providers based on the number of subscribers that opt for the package in a given month.

For purposes of calculating the royalty payment due, content providers contractually require the content distributor to report content royalty payment data to the content provider periodically (typically monthly) and by a specified deadline. Content royalty payment data can include the number of content units purchased, the unit rate per unit of content and the total amount due.

For content distributors, completing the necessary work to correctly submit content royalty payment information to all of their content providers within the time constraints named in their contracts is challenging for the following reasons:
a. Heterogeneous reporting requirements across content providers—There is no industry standard set of content royalty payment data. Different content providers require different content royalty payment data elements. Content distributors cannot use a standard content royalty payment format for all content providers, but instead must create different reports for each one. Content distributors must keep track of and comply with the multiple reporting requirements or risk being in breach of contract. This is repetitive and time-consuming.
b. Heterogeneous reporting requirements within content providers—Where a single content provider (such as ESPN) offers different products (ESPN, ESPN2, ESPN3), the distributor will often be required to remit different data for each product in separate reports. This is repetitive and time-consuming.
c. Preparation of Content royalty payment Data—The content royalty payment data that content providers require is typically sourced from an external system such as a billing system. Because the output from these systems is not suitable for royalty payment calculation, the content distributor must often manually process this data to get it in a suitable form. This process can be time-consuming and is prone to errors.
d. Large number of content providers—Content distributors have contracts with a large number of content providers. Content royalty payment reporting is resource and time-intensive for this reason.
e. Deadlines—Content distributors who do not meet contractually stipulated reporting requirements are considered to be in breach of contract and may be subject to financial penalties.

Content providers collect key data points from their content distributors in order to calculate the royalty payment due. The royalty contracts with these distributors stipulate the deadline by which this data must be received as well as the actual data elements to be provided. Once the data is received, it is examined for errors, after which it is input into an external system that calculates the royalty payment due and that takes care of any accounting procedures. There are a number of challenges with this process today:
a. Distributors use different transmission formats—Different distributors use different mechanisms for sending their data. Some send spreadsheets by email. Others physically mail paper forms. Still others fax the information.
b. Data contains errors—Data elements may be incorrect or missing altogether. If not found and corrected, bad data causes incorrect royalty payments.
c. Missed deadlines—Content distributors who do not meet deadlines must be chased down via phone call and email.
d. Large number of distributors—Successful content providers have royalty contracts with a large number of distributors. The scale of the processing burden, including monitoring on-time content royalty payment reporting, is a significant drain on resources.
e. Transferring data into external royalty payment accounting system—Once received, the content royalty payment data must be transferred to an external system that calculates the royalty payment and that executes any accounting procedures. Where these systems offer some automated means of importing data, they require the data be in a particular format, often a file of a particular type and structure. The content distributor must therefore manually manipulate the content royalty payment data to fit this format. This is resource-intensive and prone to error.

### BRIEF SUMMARY

Briefly described the present disclosure describes a system for gathering and exchanging royalty payment information among content providers and content distributors. The system contains one or more of the following elements:
a. User Interfaces—Secured via user name and password, user interfaces provide access to system functionality for the various users. User access is restricted to the functionality and data to which they have a business need.
b. Database—Stores all applicable data, including authorized content distributors and content providers, product catalogs, content royalty payment information, application settings, etc.
c. Routing & Interface Module—Facilitates the exchange of information between a content distributor and its many content providers. The Routing & Interface Module is capable of importing data from content distributors using a defined API and of exporting data to content providers via a defined API or by producing an output file. The Routing Engine also monitors contractual deadlines and provides transaction receipts.

Content distributors use the invention to submit a single superset of content royalty payment data, to transmit that data to multiple content providers according to each content provider's requirements and to receive notification that their data was sent. This saves the distributor time, promotes accuracy and ensures royalty contract compliance.

Content providers use the invention to collect and consolidate content royalty payment information from multiple distributors and intermediaries in a timely fashion, to prevent data errors and to transmit that data into an external system for accounting purposes.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 illustrates an exemplary television network that includes a content royalty payment system.

FIG. 2 illustrates a method for exchanging content royalty payment information.

FIG. 3 illustrates another embodiment of a method for submitting content royalty payment information

FIG. 4 illustrates a method for setting up an application user account

FIG. 5 illustrates a method for retrieving content royalty payment data

FIG. 6 illustrates an exemplary screen for capturing content royalty payment data

FIG. 7 illustrates an exemplary screen for maintaining systems and channel lineups

FIG. 8 illustrates an exemplary screen for monitoring and downloading submissions

FIG. 9 illustrates an exemplary database schema for the database of FIG. 1

FIG. 10 depicts an exemplary remittance summary report

FIG. 11 depicts an exemplary content distributor trend report

FIG. 12 depicts an exemplary content provider royalty payment report

### DETAILED DESCRIPTION

For promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. Limitations of scope should be determined in accordance with and as expressed in the claims.

### Overview

Briefly described, aspects of the claimed invention relate to computer-implemented systems and methods that manage the collection and exchange of content royalty payment information between content distributors (e.g. cable TV operators, satellite TV operators) and content providers (e.g. Fox® network, MTV®, Sci-Fi Channel®, ESPN®, HBO®, etc.) that charge certain fees (or royalties) for their content according to predetermined variables within the contracts. The various embodiments of the disclosure provide a tool that allows: a.) content distributors to capture content royalty payment data, to transmit that data to multiple content providers and to receive a receipt of the transaction; b.) content providers to collect and consolidate content royalty payment information from multiple content distributors and to retrieve and transmit that information to external systems.

### DEFINITIONS

The following terms will be used throughout the present disclosure and are defined here for the purpose of clarity and convenience. These definitions, however, are not meant to be limiting to the scope of the disclosure, which is defined by the claims:

Content Royalty Payment Data—Information needed to calculate a royalty payment for content distributed. Examples include the numbers of units sold, the applicable rate per unit of content and the total amount due, calculated by multiplying the number of units sold by the unit rate.

Content Consumer: The end user who receives content from a content distributor. Also referred to as a ‘customer’, ‘consumer’, ‘buyer’ or ‘subscriber’.

Content Provider: Owners of content, also referred to as ‘content owners’. Content providers can include Pay television networks (MTV, Fox, ESPN), broadcast networks (ABC, CBS, NBC), movie studios (Disney, Fox) and other such providers. Content Distributor Distribute content licensed from Content Providers to Content Consumers. Content distributors can include cable television providers (COMCAST®, Time-Warner®, Charter®), telcos, and terrestrial or satellite TV providers (DirecTV, Dish Network).

Application Administrator—Personnel who administer and maintain the overall content royalty payment system.

Content Distributor Royalty Payment Administrator—Employee(s) of the Content Distributor responsible for paying royalties on content distributed.

Content Provider Royalty Payment Administrator—Employee(s) of the Content Provider responsible for collecting royalty revenue for content sold through a Content Distributor.

Content Provider Product Catalog—The various content products offered by the content providers to Content Distributors. Examples include video channels (ESPN SD, ESPN HD, ESPN2, ESPN University), movie titles (‘Forrest Gump’) and sports events (Title Fight).

Distributor Product Catalog—The various products offered by the content distributors for sale to Content Consumer. For example, some product offerings consist of multiple ‘Tiers’, which are collections of TV channels sold as a group to their customers. Other content products might be the sale of individual movie titles (Video on Demand).

Tier: collections of TV channels sold as a group to their customers. E.g. COMCAST® has a ‘Family Tier’ that comprises a collection of ‘family friendly’ TV channels that are often together in the channel lineup, and sold to customers as a unit. These ‘tiers’ have implications for royalty calculations to the content owners.

Channel Lineup: The predetermined order in which a collection of TV channels are arranged or grouped and sold by an operator.

Content Royalty Payment Contract terms: The terms and provisions of a content royalty contract, to which all parties involved must comply, based on which the content royalty payment is calculated.

Contract royalty payment rates: Royalty payment rates corresponding to media content, which are derived from contract terms.

System: A facility for receiving TV signals for processing and distribution over TV network, also referred to as ‘end system’.

Application User Account: In order to use the content royalty payment system, Content Distributors and Content Providers will create an Application User Account on the invention. Stored with this Application User Account will be information such as the list of authorized system users, contact information, application preferences, etc.

### Exemplary System

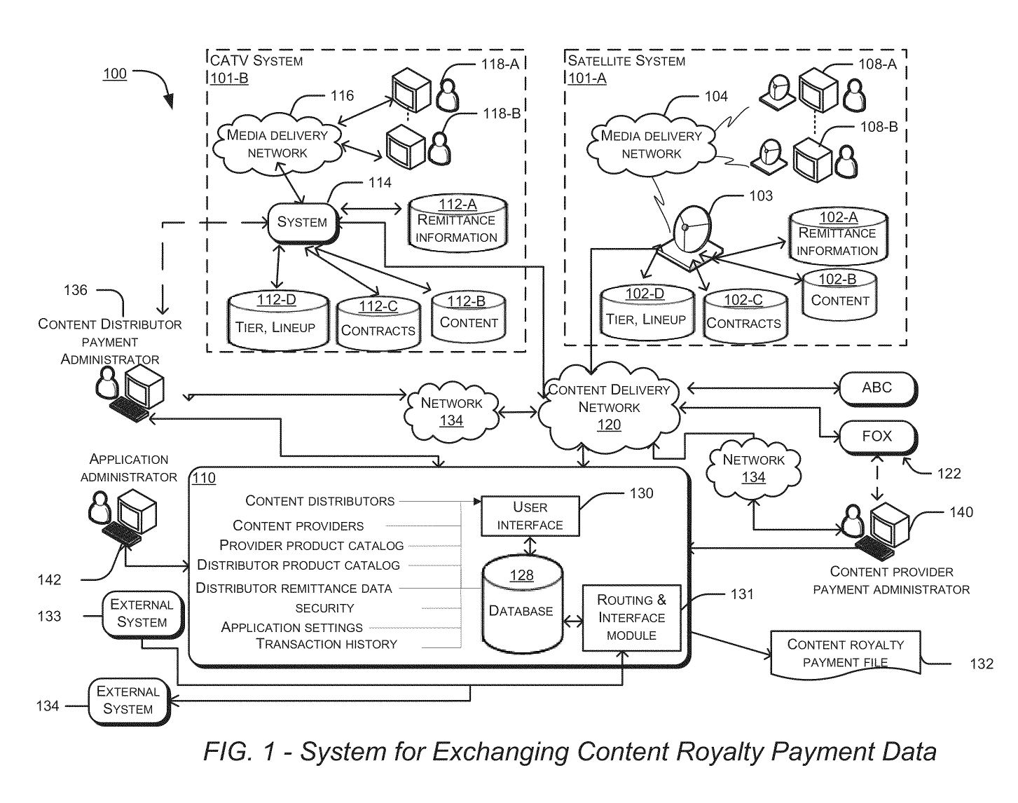

FIG. 1 illustrates an exemplary television network 100 that includes a system for collecting content royalty payment information. The television network 100 includes a satellite system 101-A having databases 102. Here, the databases 102 include, but are not limited to, a subscriber information database 102-A, a content database 102-B, a contracts database 102-C, and a tier and lineup database 102-D. The databases 102 provide inputs to a system 103, which in turn interacts with a media delivery network 104. The media delivery network 104 is typically connected wirelessly with several individual subscribers including 108-A and 108-B that may have their own dish antennas and television sets for reception.

Similarly, the television network 100 includes a cable television (CATV) system 101-B. The CATV system 101-B includes its own databases 112 that include, but are not limited to, a subscriber information database 112-A, a content database 112-B, a contracts database 112-C, and a tier and lineup database 112-D. The databases 112 provide inputs to a system 114, which acts as an interface between the databases 112 and a media delivery network 116. The media delivery network 116 is typically connected though coaxial cables to several individual subscribers including 118-A and 118-B, that may have their own television sets for media reception and viewing.

In FIG. 1, both distributors—the satellite system 101-A and the CATV system 101-B—are shown connected to a content delivery network 120. It will be understood by those skilled in the art that several other operators may additionally be connected to the content delivery network 120, such that content may be delivered to subscribers through any operator such as telcos and terrestrial networks.

The content delivery network 120 receives content from content providers 122, such as MTV®, Fox® network, CNN®, ABC®, NBC®, etc. The content delivery network 120 is further connected to a content royalty payment system 110 (referred to as royalty payment system 110 hereinafter).

The royalty payment system 110 includes a database 128, which carries information related to various aspects of content royalty payment processing including content distributors, content providers, provider product catalog, distributor product catalog, content royalty payment information, security, application settings and transaction history.

The user interface 130 may, in certain embodiments, facilitate various functions, such as setup and management of tiers, setup and management of channel lineups, setup and management of subscribers, setup and management of user security, submission of content payment information, retrieval of content payment information and analytical reporting. A content royalty payment file 132 is generated by the routing & interface module 131. In some implementations, the interface module 131 is connected to an external system 133, from which it imports content royalty payment data. This information is stored in the system 110.

In some implementations, the interface module 131 is connected to an external system 134, to which it exports the content royalty payment file 132.

The content delivery network 120 is further associated, through a network 134, with a Content Distributor Royalty Payment Administrator 136 and Content Provider Royalty Payment Administrator 140. The Content Distributor Royalty Payment Administrator 136 interacts with the various parts of the television network 100, such as the network 134 and the content royalty payment system 110, to view lineups, arrange or rearrange the lineups and tiers for business and promotional purposes, to submit content royalty payment data and to run reports. The Content Provider Royalty Payment Administrator 140 interacts with the various parts of the television network 100, such as the network 134 and the content royalty payment processing system 110, to view content royalty payment information and run reports.

The Application Administrator 142 interacts with the content royalty payment system 110 to perform overall system maintenance.

### Exemplary Methods

The following sections describe exemplary methods for carrying out one or more embodiments of the present disclosure. The methodology described herein is generally intended to describe various features and functionality of various system components described previously. The order in which the method steps are described is not intended to be construed as a limitation and any number of the described method blocks can be combined in any order to implement the method, or an alternate method. Additionally, individual blocks may be deleted from the methods without departing from the spirit and scope of the subject matter described herein. Furthermore, the method can be implemented in any suitable hardware, software, firmware, or combination thereof.

In particular, the disclosed methods execute in the television network 100 to allow the exchange of content royalty payment information among Content Providers and Content Distributors.

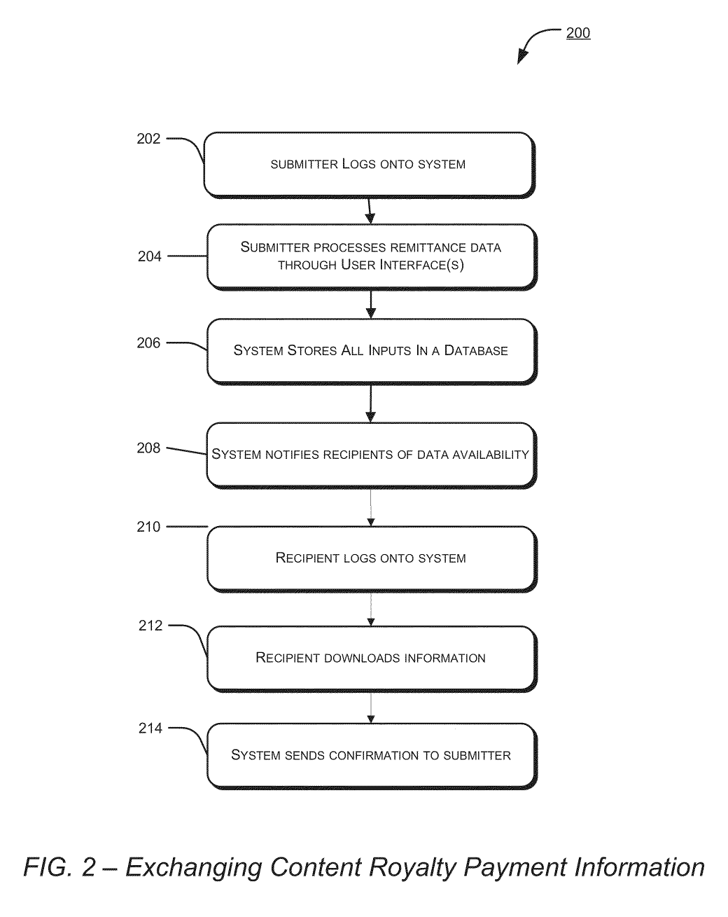

FIG. 2 illustrates a method 200 for exchanging content royalty payment information between submitters (Content Distributors) and recipients (Content Providers), according to one of the embodiments of the present disclosure. The method 200 is utilized by payment administrator personnel via the content royalty payment system 110 and the user interface 130.

At step 202, the Content Distributor attempts to log onto the system by providing a user name and password. The system verifies this information against a list of authorized users stored in the database in order to grant or deny access. If the information is incorrect, the system will provide an error message and prompt the user to correct the problem. After 3 unsuccessful attempts, the system will provide the user a means to reset his/her password using security questions. Where the user provides a user name that doesn't exist, the system will prompt the user to register.

Once successfully logged in, the Content Distributor will use the user interface to capture the necessary content royalty payment information at step 204. This may include providing subscriber by tier for each system. In some cases, the Content Distributor may need to perform maintenance of key information (add systems, launch channels, etc.) as part of the process. They will accomplish these additional activities using the user interface as well. The system will provide validation that the inputs provided are correct in order to prevent errors.

At step 206, once the Content Distributor has successfully provided the appropriate information, the system stores the data in the database 128. Confirmation that the information has been successfully saved is provided to the Content Distributor.

At step 208, the system then notifies all of the Content Providers with contractual relationships with that Content Distributor that content royalty payment information has been received and is available for download. This may be accomplished by email sent to the Content Provider using the email address stored in the system for particular recipient. The Content Provider may also receive this notification when they log on to the system. The system notifies the Content Distributor once notification has been successfully sent to all intended recipients.

Having received email notification that data is available, the Content Provider logs onto the system by providing a user name and password at step 210. The system verifies this information against a list of authorized users stored in the database in order to grant or deny access. If the information is incorrect, the system will provide an error message and prompt the user to correct the problem. After 3 unsuccessful attempts, the system will provide the user a means to reset his/her password using security questions. Where the user provides a user name that doesn't exist, the system will prompt the user to register. If the user is a Medea user, log on occurs behind-the-scenes via system interface (need to elaborate here)

Once successfully logged in, the Content Provider exports the content royalty payment information as a standard file in step 212.

At step 214, the system then sends a notification to the Submitter confirming the successful transmission of content royalty payment information to that Recipient. A separate notification is sent for each Content Provider downloading the data.

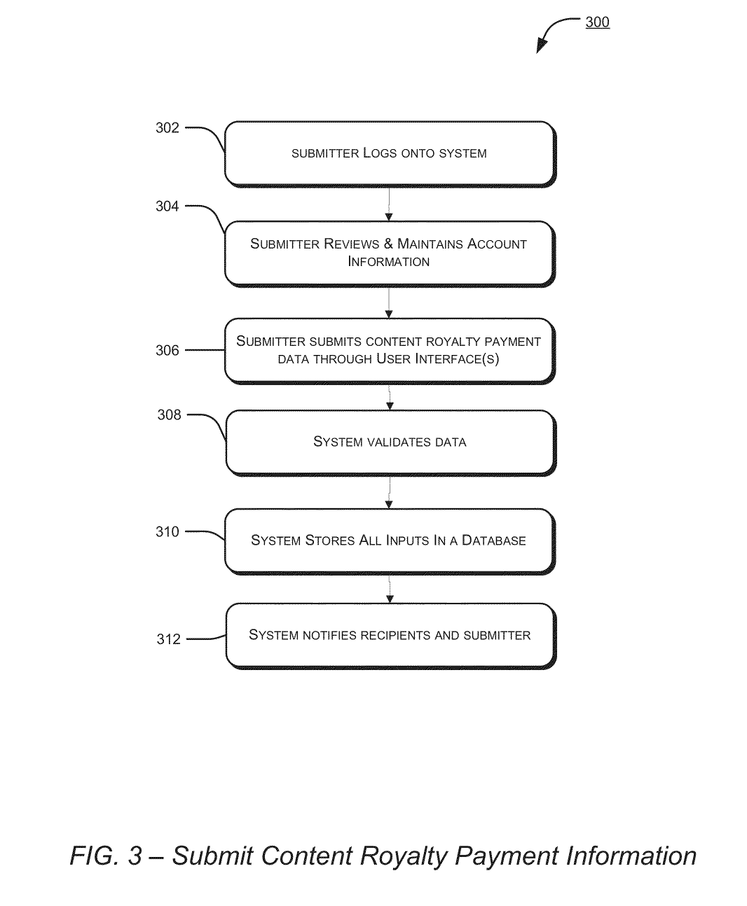

FIG. 3 illustrates another embodiment of a method 300 for exchanging content royalty payment information between submitters (Content Distributors) and recipients (Content Providers), according to one of the embodiments of the present disclosure. The method 300 is utilized by content distributor royalty payment administrator via the content royalty payment system 110 and the user interface 130.

At step 302, the process begins when the submitter logs onto the system by providing a user name and password. The system verifies this information against a list of authorized users stored in the database in order to grant or deny access. If the information is incorrect, the system will provide an error message and prompt the user to correct the problem. After 3 unsuccessful attempts, the system will provide the user a means to reset his/her password using security questions.

At step 304, upon successful logon, the system displays the account information currently stored in the database for that Content Distributor. This includes information such as: system structure, tiers offered, services offered, channel lineups by system, etc. The submitter may choose to make changes to this information using tools provided for this purpose.

At step 306, the submitter provides the necessary content royalty payment data using the tools provided for this purpose. The submitter may provide data for the current reporting period or for past reporting periods. The user may save the data to the database at any point and return later to complete the exercise.

At step 308, the system executes a number of validation rules in order to identify potential errors in the data. Any potential problems are communicated to the user via error messages displayed in the user interface.

At step 310, the system saves the data to the database.

At step 312, the system then sends notifications to the following parties: a.) all Recipients with whom the submitter has contractual relationships, notifying them that data is available for download; b.) the Submitter, notifying him that the Recipients have been notified.

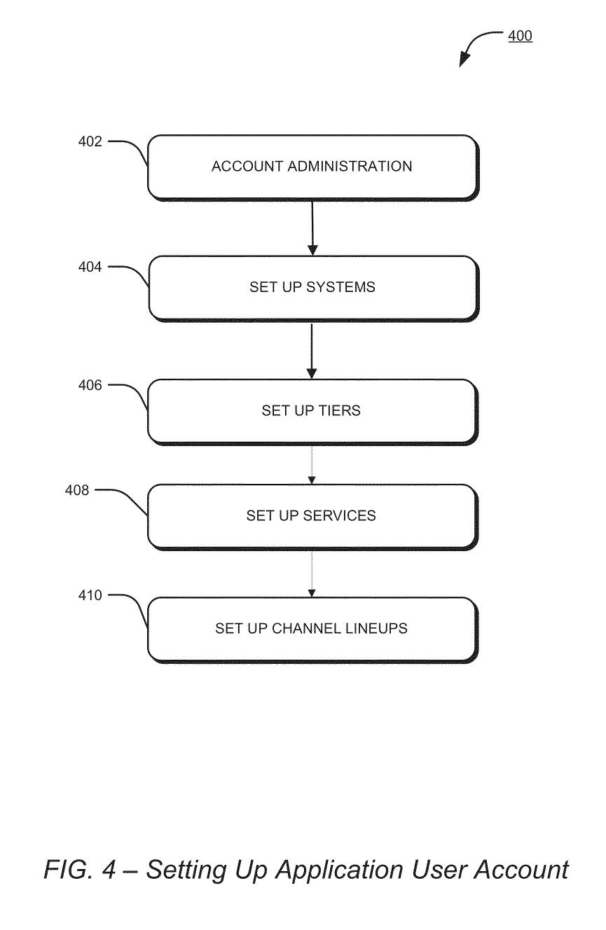

FIG. 4 illustrates another embodiment of a method 400 for exchanging content royalty payment information between submitters (Content Distributors) and recipients (Content Providers), according to one of the embodiments of the present disclosure. The method 400 is utilized by content distributor royalty payment administrators via the content royalty payment system 110 and the user interface 130.

The present embodiment focuses on first time set up of an Application User Account. The system guides the user through a sequential setup process wherein the user configures the application for their ongoing use, in but not limited to the areas below:
a. In Step 402, account administration—Add and maintain users allowed to access the User Account, change passwords, provide contact information and specify application defaults
b. In Step 404, set up systems—Add and maintain the list of systems offering content
c. In Step 406, set up tiers—Add and maintain tiers offered. This involves mapping the tier names used by the user to the standard tier names set up by the Application Administrator.
d. In step 408, set up services—Add and maintain the different content products offered
e. In step 410, set up channel lineups—Add and maintain composition and arrangement of TV channels offered

Over time, the user will likely need to make updates to the elements above. The system will provide—via the user interface—tools to maintain each element individually.

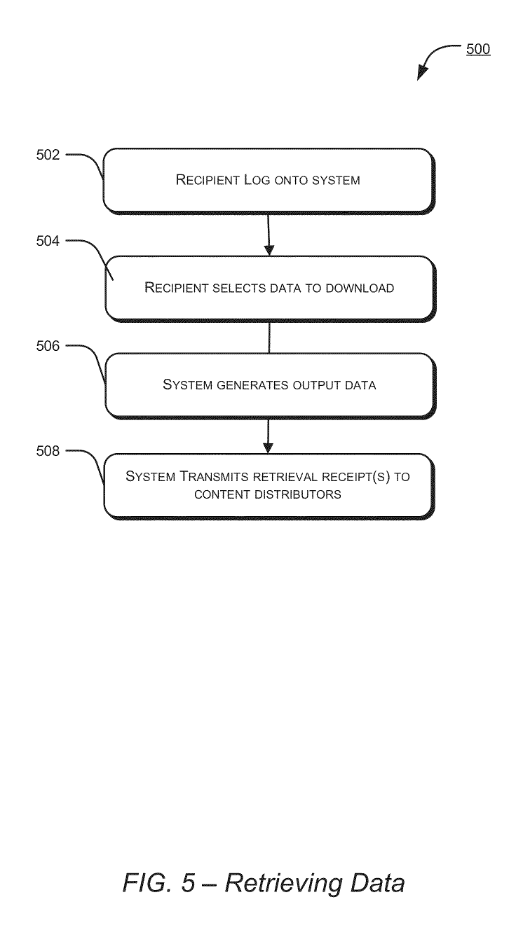

FIG. 5 illustrates another embodiment of a method 500 for exchanging content royalty payment information between submitters (Content Distributors) and recipients (Content Providers), according to one of the embodiments of the present disclosure. The method 500 is utilized by content provider royalty payment administrator via the content royalty payment system 110 and the user interface 130. The present embodiment focuses on how a Recipient takes possession of content royalty payment information submitted by a Content Distributor.

The process begins when the Recipient logs onto the system 502 by providing a user name and password. The system verifies this information against a list of authorized users stored in the database in order to grant or deny access. If the information is incorrect, the system will provide an error message and prompt the user to correct the problem. After 3 unsuccessful attempts, the system will provide the user a means to reset his/her password using security questions.

Upon successful logon, in step 504 the system displays the content royalty payment data that is available for download. There may be multiple different submissions from multiple Content Distributors. The user then selects one or more of these submissions and initiates the download.

In step 506, the system generates an output file containing the data requested.

In step 508, the system informs the Content Distributors whose data was just retrieved that their submission has been successfully received by that Content Provider. This is done by email.

### Exemplary Content Royalty Payment System Screens

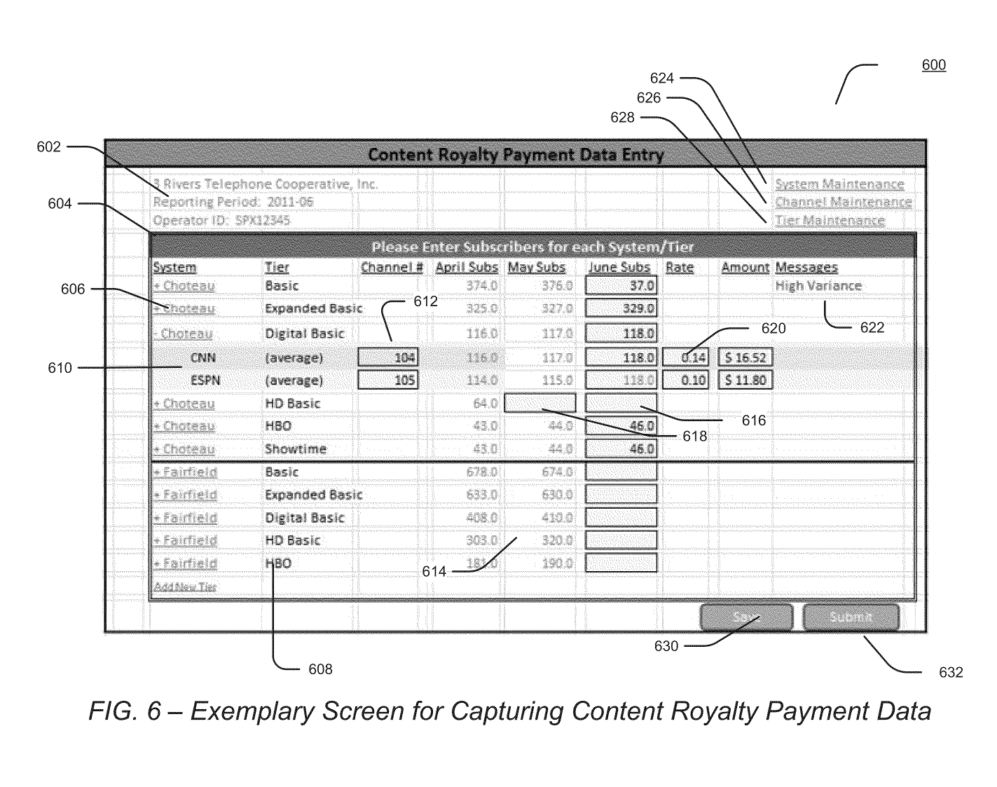

FIG. 6 illustrates an exemplary screen 600 for use by Content Distributors for entering content royalty payment information. The screen provides a header section and data entry section. The header section 602 identifies the Content Distributor and reporting period. The data entry section 604 provides the following elements relevant to entering content royalty payment data:
a. The systems 606 associated with the distributor
b. The various tiers 608 offered by each system
c. The list of channels 610 carried on each tier
d. The channel # 612 for each channel
e. Historical data 614 for the previous 2 months of subscribers
f. Mechanism 616 for capturing current month subscribers by system, by tier, by channel. Subscriber counts provided at a tier level are inherited by all of the channels on that tier. The user is free to override these subscriber counts by channel. The mechanism also accommodates various subscriber types, such as residential, commercial and hospitality.
g. Mechanism 618 for providing previous month subscribers by system, by tier, by channel—The user may change previously submitted information using the system.
h. Mechanism 620 for providing current month rate
i. An area for receiving error messages 622
j. Mechanism 624 to administer the systems associated with that distributor, to include creating new systems, deactivating systems, splitting systems, merging systems
k. Mechanism 626 to administer the channels listed, to include: the ability to drop a channel from an existing tier; the ability to move an existing channel to a different tier; the ability to add a new channel to a tier
l. Mechanism 628 to administer the tiers listed, to include: The ability to add a new tier; he ability to delete an existing tier
m. Mechanism 630 to save the current work and return to finish later
n. Mechanism 632 to mark the submission complete and send to the recipients
   It is obvious that these fields may vary depending on system requirement without departing from the scope of this disclosure.

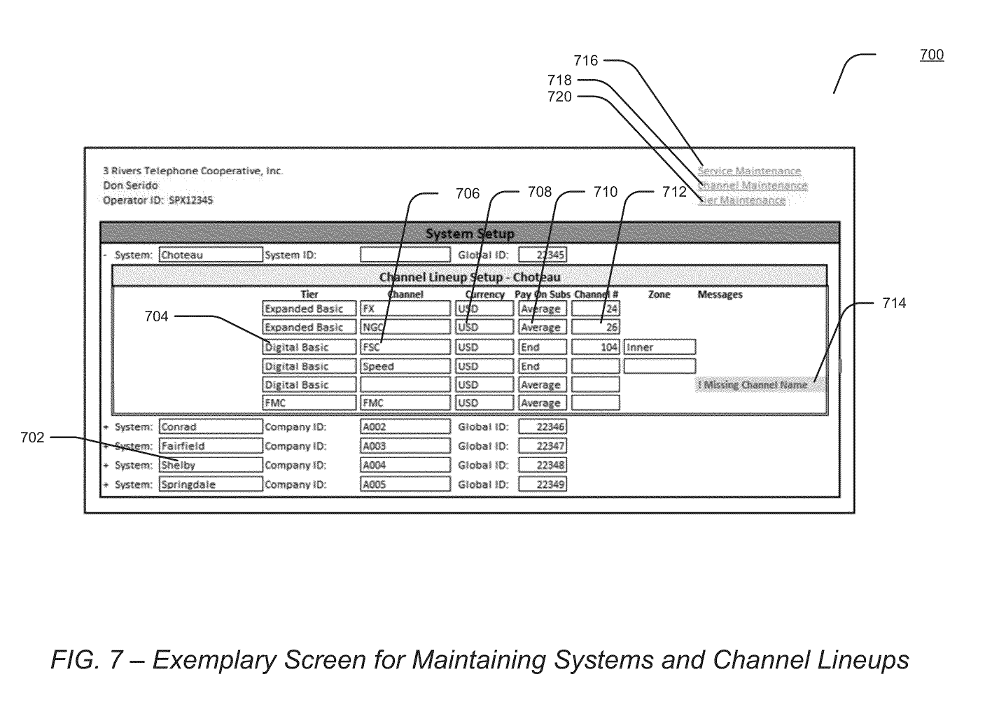

FIG. 7 illustrates an exemplary screen 700 for maintaining systems and channel lineups used by Content Distributors during initial Account setup and ongoing maintenance. This screen provides, but is not limited to, the following relevant elements:
a. All Systems 702 associated with the Distributor, to include system name and multiple identifier (ID) fields
b. The various tiers 704 offered by each System
c. The list of Channels 706 carried on each tier
d. For each Channel, the Channel name 706, currency 708, the ‘pay on sub’ method 710 by which subscriber count is calculated for payment purposes, the channel number 712
e. An area for receiving error messages 714
f. The ability to administer the systems associated with that distributor, to include creating new systems, deactivating systems, splitting systems, merging systems
g. The ability to administer the channels listed 716, to include: the ability to drop a channel from an existing tier; the ability to move an existing channel to a different tier; the ability to add a new channel to a tier
h. Mechanism 718 to administer the channels listed, to include: the ability to drop a channel from an existing tier; the ability to move an existing channel to a different tier; the ability to add a new channel to a tier
i. The ability to administer the tiers listed 720, to include: the ability to add a new tier; the ability to delete an existing tier
   It is obvious that these fields may vary depending on system requirement without departing from the scope of this disclosure.

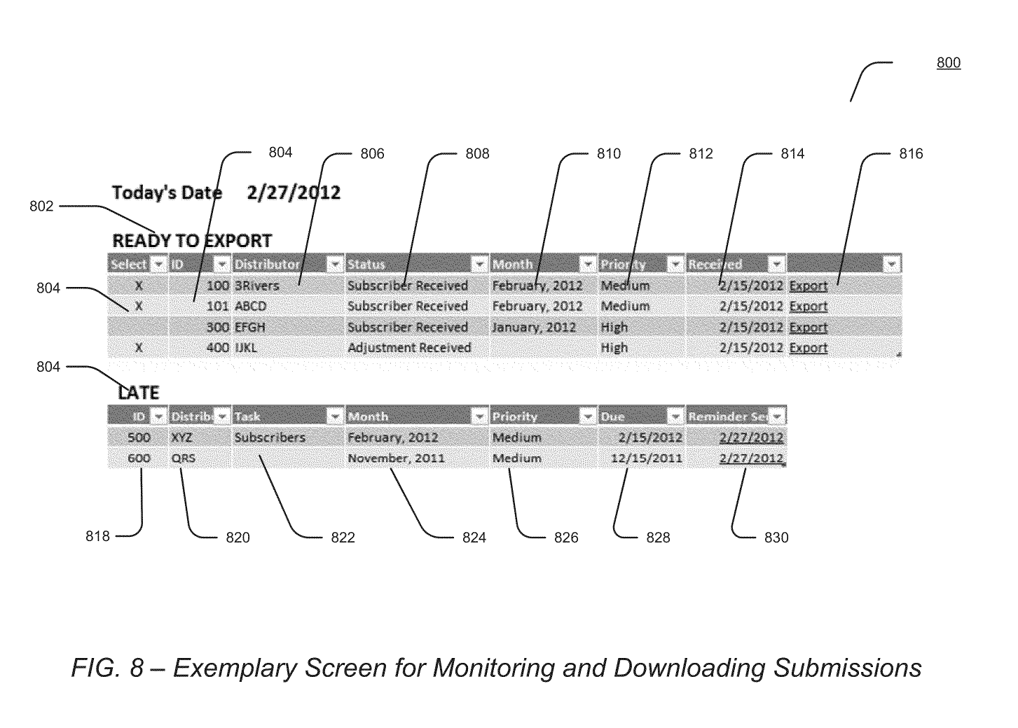

FIG. 8 illustrates an exemplary screen 800 used by Content Providers to monitor the status of Content Distributors submissions and to download those that are available. This screen provides, but is not limited to, the following relevant elements:
a. List of Submissions that are available for download 802- Each entry in the list has the following informational and functional elements:
   i. ID 804—the unique ID assigned to the transaction
   ii. Distributor 806—the name of the Distributor who submitted the data
   iii. Status 808—Indicates the state of the entry
   iv. Month 810—The reporting month with which the entry is associated
   v. Priority 812—The urgency associated with the entry.
   vi. Received 814—A timestamp of when the submission was first received by the Recipient.
   vii. A mechanism for selecting multiple entries 804
   viii. A mechanism for exporting one to many selected entries to an output file 816
b. List of Content Distributors who have passed the deadline for submitting data 804—Each entry in the list has the following informational and functional elements:
i. ID 818—the unique ID assigned to the Content Distributor
ii. Distributor—820 the name of the Distributor who submitted the data
iii. Status 822—Indicates how late the submission is
iv. Month 824—The reporting month with which the entry is associated
v. Priority 826—The urgency associated with the entry
vi. Due Date 828—The date the submission was due
vii. Reminder Sent 830—The date on which the last reminder was sent by the system

### Exemplary Database Schema

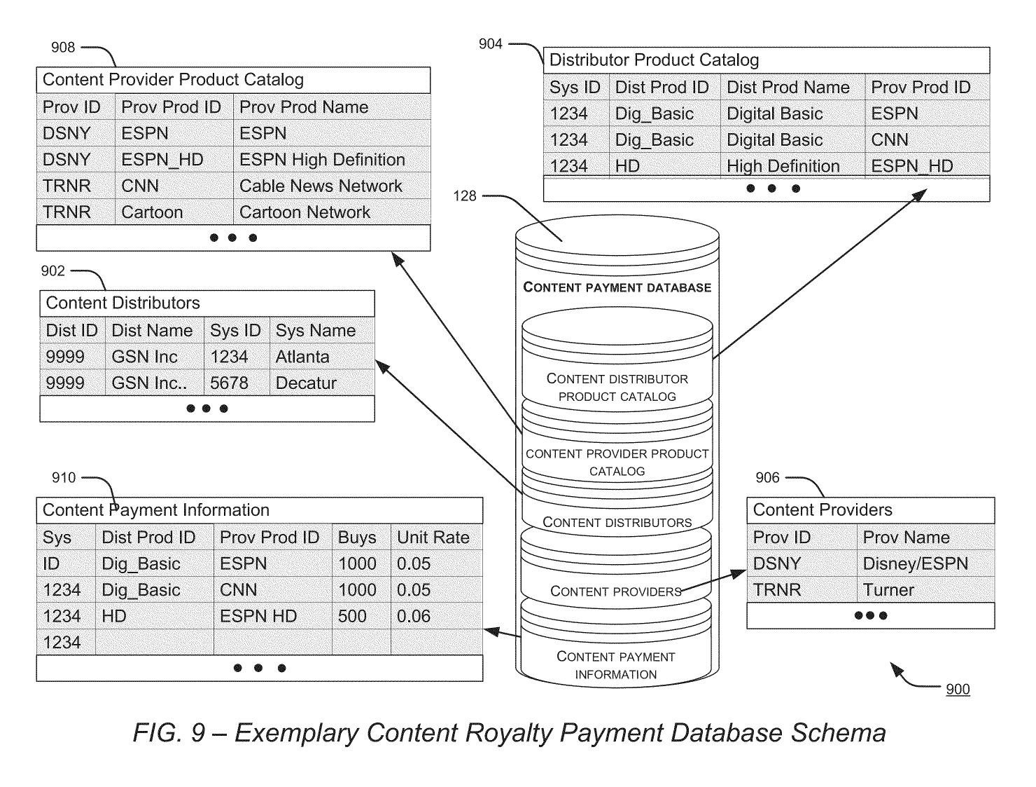

FIG. 9 illustrates an exemplary database schema 900 for the database 128, depicting sub-databases for content distributors 902, content distributor product catalog 904, content providers 906, content provider product catalog 908, and content payment information 910. It should be noted that as shown in FIG. 1, the database 128 may include several other sub-databases, although only three have been shown here.

Content Provider 906 includes unique Provider ID's (Prov ID) and the Provider Name (Prov Name).

Content Provider Product Catalog 908 equates one to many Content Provider Products (Prov Prod ID+Prov Prod Name) to a Content Provider (Prov ID)

Content Distributors 902 includes a unique identifier for the content distributor, the distributor name and one to many systems that belong to that distributor, each of which systems is uniquely identified with a System ID.

Distributor Product Catalog 904 contains, for each system uniquely identified by Sys ID, the various Content Provider Products (Prov Prod ID) that are packaged into one to many Distributor Products, identified by a unique ID (Dist Prod ID) and common name (Dist Prod Name).

Content Payment Information 910 contains, by System (Sys ID), the number of times (Buys), and at what unit rate (Unit Rate) a particular piece of content (Prov Prod ID) was sold by a Content Distributor. It also captures the Distributor Product (Dist Prod ID) in which the content was packaged.

Similar database schemas can be designed for tier, service, lineup, system, authorized users, application parameters, etc.

### Exemplary Reports

The content royalty payment system 110 provides a number of reports to assist in the exchange of information. The reports may be exported in a variety of formats, including PDF and Microsoft Excel.

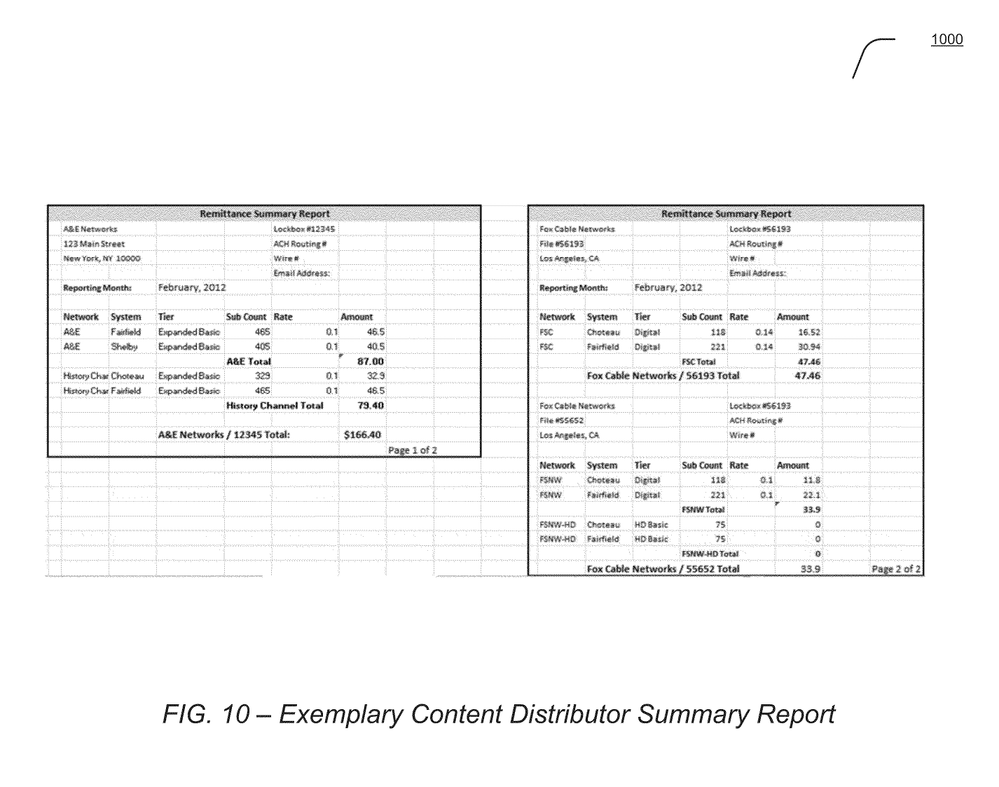

FIG. 10 depicts an exemplary Distributor Content Royalty Payment Summary Report 1000, which provides a record of the content royalty payment information submitted to the various Content Providers (A&E Networks, Fox Cable Networks) by a Content Distributor for the month of February, 2012. Similar reports with varying template structures may be generated based on the user's requirements, such as, but not limited to, providing a report for multiple months, multiple content owners.

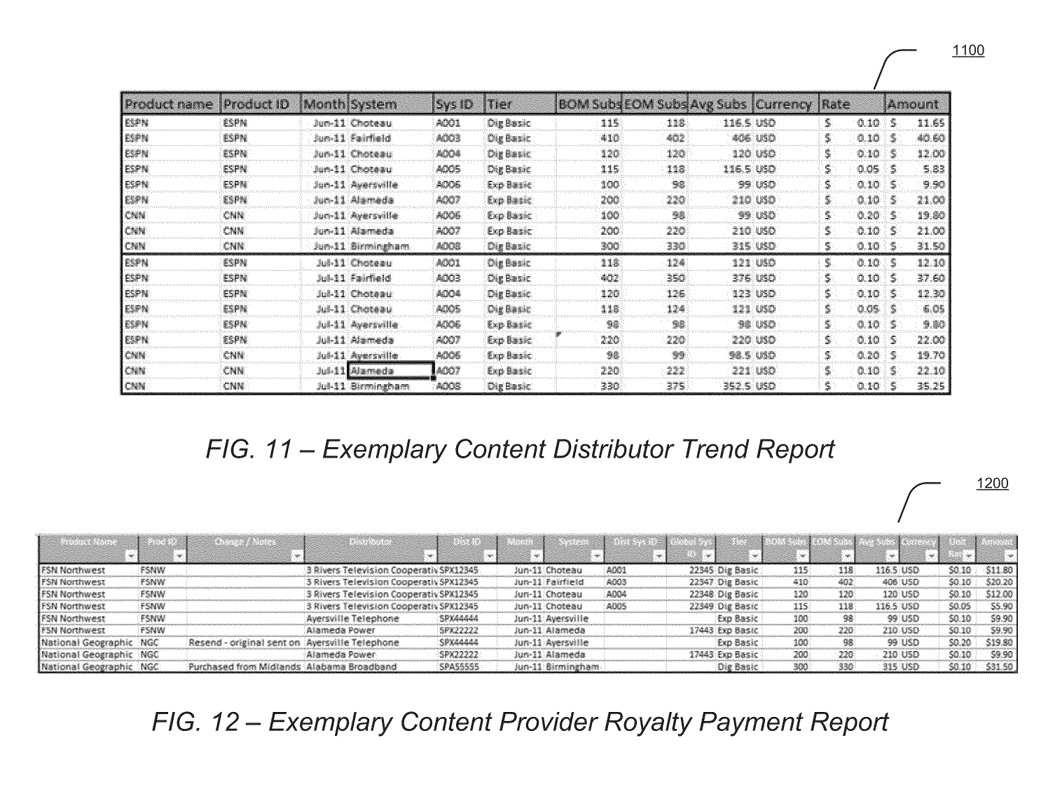

FIG. 11 depicts an exemplary Distributor Trend Report 1100, which provides historical content royalty payment data across multiple months (June and July, 2011). Similar reports with varying template structures may be generated based on the user's requirements, such as, but not limited to, providing a report for multiple months, multiple products, systems, tiers, etc.

FIG. 12 depicts an exemplary Content Provider Royalty Payment Report 1200, which is used by the Content Provider to retrieve the content royalty payment data submitted by Content Distributors for a particular month (in this case, June of 2011). Similar reports with varying template structures may be generated based on the user's requirements, such as, but not limited to, providing a report for multiple distributors, date submitted, etc.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present inventions is defined by the appended claims rather than the foregoing description and the exemplary embodiments described therein.

What is claimed is:

1. A computer-implemented method for providing content royalty payment information to a plurality of content providers, the royalty payment information derived as a result of delivery of predetermined content by a plurality of content distributors to a plurality of content consumers, the content provided to the content distributors by the content providers, so that the content providers can determine royalty payments to be expected from the content distributors, comprising the steps of:
providing a networked computer system with networked connections to a plurality of content distributors and a plurality of content providers, the computer system including a processor for executing computer program modules and a content royalty payment database;
providing a content distributor user interface (UI) computer program module in said computer system for collecting content royalty payment data from a content distributor, the content royalty payment data including but not limited to, one or more of data items such as royalty rates, the number of content consumers subscribing to a tier comprising particular collection of TV channels, the number of content units purchased, and the unit rate per unit of content, for one or more content distribution networks associated with the content distributor, for specific content made available by selected content providers;
providing a content provider user interface (UI) computer program module in said computer system for providing a content provider royalty payment report file in a predetermined format as specified by the content provider for use in connection with its specific accounting system reflecting expected content royalties from one or more content distributors;
receiving content royalty payment data input comprising data corresponding to one or more of royalty rates, the number of content consumers subscribing to a tier comprising a particular collection of TV channels, the number of content units purchased, and the unit rate per unit of content in response to execution of said content distributor UI computer program modules in a data session associated with a particular content distributor, the content royalty payment data associated with the content associated with each one of a selected subset of content providers that provide content to the content distributor;
processing the data input in the preceding step for format, consistency, business rules, etc. and storing the processed (transformed) data in said content royalty payment database;
generating a content provider royalty payment report file on behalf of each of the content providers associated with the content royalty payment data session of the content distributor and storing said report file in said content royalty payment database queued for delivery to each content provider;
in response to completion of the preceding processing step, notifying a selected subset of said content providers of the entry of data by said content distributor that includes expected royalty payment data associated with the content delivered by said selected subset of content providers to said content distributor;
in response to actuation by a content provider royalty payment administrator subsequent to said notifying step, executing the content provider UI computer program module to display a content provider royalty payment report file delivery screen; and
in response to an input by said content provider royalty payment administrator, communicating the content provider royalty payment report file to a designated computer system of the content provider.

2. The computer-implemented method of claim 1, wherein the content distributor user interface (UI) computer program module in said computer system further provides channel lineup and tier management for each of the content distributors.

3. A content royalty payment system for gathering and exchanging content royalty payment information among content providers and content distributors, comprising:
one or more user interfaces through which authorized users access system functionality in a secure manner;
a database which stores all applicable data, including authorized content distributors and content providers, product catalogs, content royalty payment information, application settings, and
a routing & interface module to facilitate the transfer of information.

4. The system of claim 3, wherein the user interface is configured to allow:
capture of content payment data;
data validation and error messaging;
confirmation when data is successfully saved to the database;
confirmation when data is successfully submitted;
notification to content providers that data is available for review, download;
selection and review of current and historical content payment data;
download content payment data to external report; and
confirmation when data has been accepted by content provider.

5. The system of claim 3, wherein the user interface is configured to allow use by content distributors, content providers and application administrators for:
maintaining user access;
maintaining tiers;
maintaining systems; and
maintaining channel lineups.

6. The system of claim 3, wherein the user interface is configured to allow:
view status of data submissions;
select and view data; and
download data.

7. The system of claim 3, wherein the data further includes:
a collection of content providers;
a collection of content distributors and their systems;
a catalog of content products offered by content providers to content distributors;
a catalog of content products offered by content distributors to content distributors; and
a collection of content payment data submitted by content distributors to content providers.

8. The system of claim 3, further comprising a data access security module configured to define user access rights for providing system input and viewing system output.

9. The system of claim 3, further comprising an export module configured to export the content royalty payment data for use in external systems.

10. The system of claim 3, wherein the system provides reports including one or more of:
content distributor content royalty payment report,
content distributor trend report,
distributor trend report.

11. A method for gathering and exchanging content royalty payment information among content providers and content distributors, comprising:
one or more user interfaces through which authorized users access system functionality in a secure manner;
a database which stores all applicable data, including authorized content distributors and content providers, product catalogs, content royalty payment information, application settings, etc.; and
a routing & interface module to facilitate the transfer of information.

12. The method of claim 11, wherein the user interface is configured to allow:
capture of content payment data;
data validation and error messaging;
confirmation when data is successfully saved to the database;
confirmation when data is successfully submitted;
notification to content providers that data is available for review, download;
selection and review of current and historical content payment data;
download content payment data to external report; and
confirmation when data has been accepted by content provider.

13. The method of claim 11, wherein the user interface is configured to allow use by content distributors, content providers and application administrators for:
maintaining user access;
maintaining tiers;
maintaining systems; and
maintaining channel lineups.

14. The method of claim 11, wherein the user interface is configured to allow:
view status of data submissions;
select and view data; and
download data.

15. The method of claim 11, wherein the data further includes information related to one or more of:
a collection of content providers;
a collection of content distributors and their systems;
a catalog of content products offered by content providers to content distributors;
a catalog of content products offered by content distributors to content distributors;
a collection of content payment data submitted by content distributors to content providers.

16. The method of claim 11, further comprising a data access security module configured to define user access rights for providing system input and viewing system output.

17. The method of claim 11, further comprising an export module configured to export the content royalty payment data for use in external systems.

18. The method of claim 11, further comprising providing reports including one or more of:
content distributor content royalty payment report;
content distributor trend report; and
distributor trend report.
